(19) United States
(12) Patent Application Publication
(10) Pub. No.: US 2010/0262610 A1
(43) Pub. Date: Oct. 14, 2010

(54) Identifying Subject Matter Experts

(75) Inventors: JAN E. ACOSTA, Austin, TX (US); CARRIE J. BRACHT, AUSTIN, TX (US); JAMES L. JONES, AUSTIN, TX (US); KAREN A. ROSENGREN, ROUND ROCK, TX (US); ELIZABETH V. WOODWARD, CEDAR PARK, TX (US)

Correspondence Address: INTERNATIONAL CORP (BLF), c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 12/421,089

(22) Filed: Apr. 9, 2009

(51) Int. Cl. G06F 17/30

(52) U.S. Cl. 707/748; 707/E17.108; 707/723

(57) ABSTRACT

Identifying subject matter experts including receiving, by an SME search engine from a user, a search request including text corresponding to a particular subject matter; finding, in one or more information repositories, in dependence upon the text of the search request, one or more resources, including determining for each resource a credibility rating; identifying one or more potential subject matter experts associated with the resources; calculating, for each of the potential subject matter experts, in dependence upon the credibility rating of the each resource, a weighted expert score representing an estimated level of expertise for each potential subject matter expert; and returning, to the user by the SME search engine as one more search results, the potential subject matter experts in order of the weighted expert scores along with resources associated with the potential subject matter experts.

### BACKGROUND OF THE INVENTION

1. Field of the Invention

The field of the invention is data processing, or, more specifically, methods, apparatus, and products for identifying subject matter experts.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Computers today often provide tools for increasing knowledge, allowing easy and efficient access to a great amount of information. A knowledge economy is one in which knowledge is the key resource and the ability to effectively leverage knowledge plays a predominant part in the creation of wealth. In order to remain competitive, companies, states, countries, and other organizations must effectively harness and leverage the experience of their populations. Locating experts within such large organizations, however, is currently a time-consuming ‘hit-or-miss’ task. Currently methods of locating such experts are typically iterative and merely identify people having a threshold expertise in a subject specified by some predefined criterion. Iterations of these methods, however, typically stop when a predefined number of experts meeting threshold requirements are found. In these prior art methods people having even greater expertise than those identified in the iterations are not located. That is, in these prior art methods of locating experts, just enough experts meeting minimum threshold criterion are located rather than the best possible experts in the subject matter.

Other prior art techniques of locating experts rely on a person self-reporting or insufficient criterion to determine the person's expertise. Skills databases, for example, are often used to locate experts. A skill database includes information about skills people have acquired in terms of classes completed, certifications granted, self assessment of skills and the like. These types of data however demonstrate only that a person has knowledge of particular skills, not whether others view such person as an expert in a particular subject matter.

### SUMMARY OF THE INVENTION

Computer-implemented methods, apparatus, and products for identifying subject matter experts are disclosed here in which a subject matter expert is a person adept in a particular subject matter, and identifying such subject matter experts includes receiving, by a subject matter expert search engine (‘SME search engine’) from a user, a search request that includes text that corresponds to a particular subject matter; finding, in one or more information repositories, by the SME search engine in dependence upon the text of the search request, one or more resources that include content describing the particular subject matter, including determining for each resource a credibility rating; identifying, by the SME search engine, one or more potential subject matter experts associated with the resources; calculating, for each of the potential subject matter experts, by the SME search engine, in dependence upon the credibility rating of the each resource, a weighted expert score representing an estimated level of expertise for each potential subject matter expert; and returning, to the user by the SME search engine as one more search results, the potential subject matter experts in order of the weighted expert scores along with resources associated with the potential subject matter experts.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram of an exemplary system for identifying subject matter experts according to embodiments of the present invention.

FIG. 2 sets forth a flow chart illustrating an exemplary method for identifying subject matter experts according to embodiments of the present invention.

FIG. 3 sets forth a flow chart illustrating a further exemplary method for identifying subject matter experts according to embodiments of the present invention.

FIG. 4 sets forth a flow chart illustrating a further exemplary method for identifying subject matter experts according to embodiments of the present invention.

FIG. 5 sets forth a flow chart illustrating a further exemplary method for identifying subject matter experts according to embodiments of the present invention.

FIG. 6 sets forth a flow chart illustrating a further exemplary method for identifying subject matter experts according to embodiments of the present invention.

### DETAILED DESCRIPTION OF EXEMPLARY EMBODIMENTS

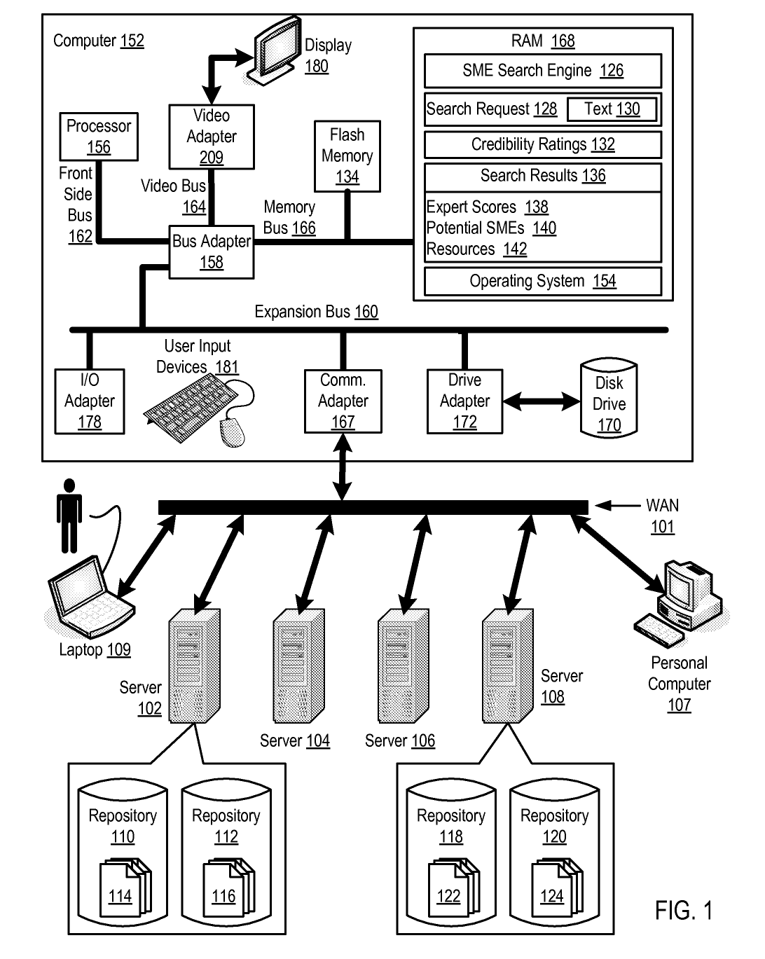

Exemplary methods, apparatus, and products for identifying subject matter experts in accordance with the present invention are described with reference to the accompanying drawings, beginning with FIG. 1. FIG. 1 sets forth a network diagram of an exemplary system for identifying subject matter experts according to embodiments of the present invention. A subject matter expert as the term is used in this specification is a person adept in a particular subject matter, such as for example, a person adept in blade server technology, a person adept in chemistry, a person adept in electrical engineering, a person adept in computer engineering, a person adept in nuclear physics, and so on.

The system of FIG. 1 includes a computer (152) which in turn includes at least one computer processor (156) or ‘CPU’ as well as random access memory (168) (‘RAM’) which is connected through a high speed memory bus (166) and bus adapter (158) to processor (156) and to other components of the computer (152). Stored in RAM (168) of the computer (152) is a an a subject matter expert search engine (‘SME search engine’) (126), a module of computer program instructions that operates generally for identifying subject matter experts in accordance with the present invention. The example SME search engine (126) of FIG. 1 operates to identify subject matter experts according to embodiments of the present invention by receiving, from a user (250), a search request (128) which includes text (130) that corresponds to a particular subject matter. The SME search engine (126) in the example of FIG. 1 may receive a search request (128) from a user (250) through various communication channels. A user (250) as the term is used here may refer, as context requires, to a person controlling operation of software and hardware or the software and hardware itself. The SME search engine (126) in the example of FIG. 1 may, for example, receive a search request (128) from a user (250) operating laptop (109) or personal computer (107) through a wide are network (‘WAN’) (101). The SME search engine (126) may also receive a search request (128) form a user (250) through the I/O adapter (178) of the computer (152) with direct input of a user input device (181), such as a keyboard or mouse. That is, the SME search engine (126) may be implemented as a server-side application executed computer remotely connected for data communications to a user's computer, or the SME search engine (126) may be implemented as a client-side application executed on a computer operated by a user (250).

The SME search engine (126) also operates to identify subject matter experts according to embodiments of the present invention by finding, in one or more information repositories (110, 112, 118, 120), in dependence upon the text (130) of the search request (128), one or more resources (142) that includes content describing the particular subject matter. In finding one or more resources (142) that includes content describing the particular subject matter, the SME search engine also determines for each resource a credibility rating (132). An information repository as the term is used in this specification refers to any type of storage medium capable of containing one or more resources accessible by an SME search engine configured according to embodiments of the present invention. Examples of information repositories include web servers, databases, file systems, and so on as will occur to readers of skill in the art.

A resource as the term is used in this specification refers to any type of data structure that includes text searchable by an SME search engine configured according to embodiments of the present invention. Examples of such resources include web pages implemented with markup documents, database records, word processing documents, spreadsheet documents, portable document format (‘PDF’) documents, extensible markup language (‘XML’) documents, and so on as will occur to readers of skill in the art. In the example of FIG. 1, four servers (102, 104, 106, 108) are connected for data communications to one another and computer (152) through the WAN (101) and each server provides to all other servers and the computer (152) access to one or more information repositories that includes resources. Server (102), for example, provides access to resources (114) in repository (110) and resources (116) in repository (112). Server (108), as another example, provides access to resources (122) in repository (118) and resources (124) in repository (120).

A credibility rating (132) as the term is used in this specification refers to a number, ratio, percentage, or the like, calculated for a resource, by a search algorithm of the search engine, that represents an affinity between text of a search request and the resource. Search engines of the prior art, such as the Google™ search engine, the Yahoo!™ search engine, the Altavista™ search engine, and so on, typically provide search results in order of such credibility ratings—those resources having the greatest affinity with the text of a search request ranked higher than those resources having lower affinity.

The SME search engine (126) of FIG. 1 also operates to identify subject matter experts according to embodiment of the present invention by identifying one or more potential subject matter experts (140) associated with the resources (142); calculating, for each of the potential subject matter experts (140), in dependence upon the credibility rating (132) of the each resource (142), a weighted expert score (138) representing an estimated level of expertise for each potential subject matter expert; and returning, to the user (250) as one more search results (136), the potential subject matter experts (140) in order of the weighted expert scores (138) along with resources (142) associated with the potential subject matter experts (140). A weighted expert score is a number, ratio, percentage, or the like that generally represents an estimated level of expertise of a person for a particular subject matter included in a search request.

Also stored in RAM (168) is an operating system (154). Operating systems useful for identifying subject matter experts according to embodiments of the present invention include UNIX™, Linux™, Microsoft™, AIX™, IBM's i5/OS™, and others as will occur to those of skill in the art. The operating system (154), SME search engine (126), search request (128), credibility ratings (132), search results (136), and so on in the example of FIG. 1 are shown in RAM (168), but many components of such software typically are stored in non-volatile memory also, such as, for example, on a disk drive (170) or Flash memory (134).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers that dynamically provide access to files of presently unmapped remote computers according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with other remote computers (132), such as the personal computer (136), web server (130), and laptop (134), and for data communications with a data communications network (100). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for identifying subject matter experts according to embodiments of the present invention include modems for wired dial-up communications, Ethernet (IEEE 802.3) adapters for wired data communications network communications, and 802.11 adapters for wireless data communications network communications.

The arrangement of local computer (152), remote computer (132), and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

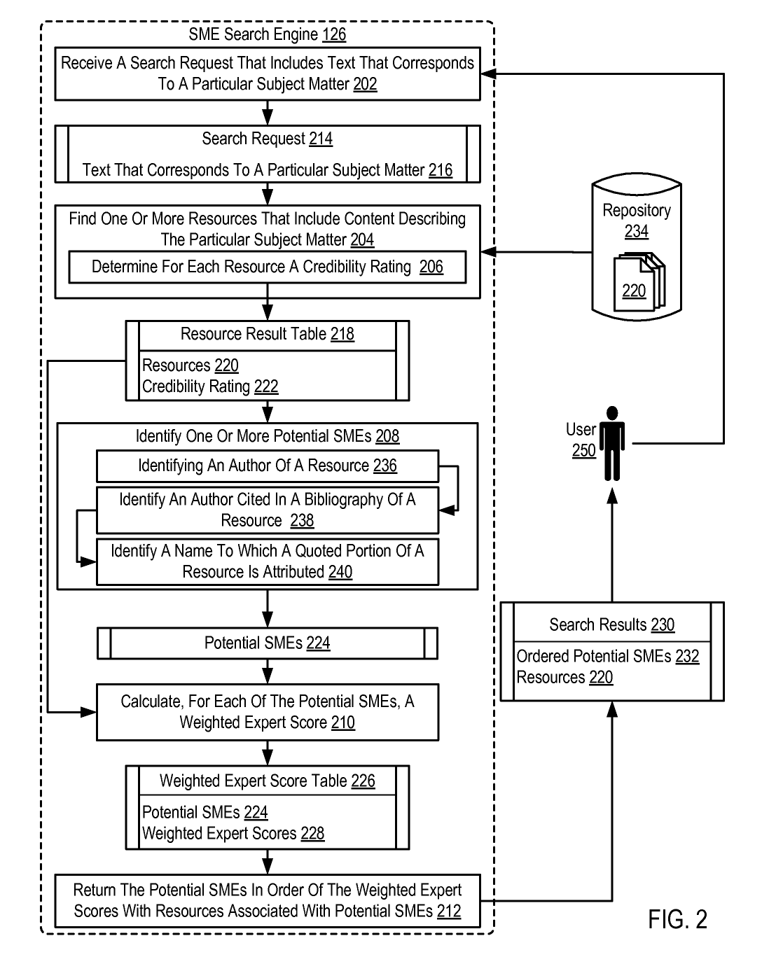

For further explanation, FIG. 2 sets forth a flow chart illustrating an exemplary method for identifying subject matter experts according to embodiments of the present invention. The method of FIG. 2 is carried out by a computer similar to the computer (152) illustrated in the system of FIG. 1.

The method of FIG. 2 includes receiving (202), by a subject matter expert search engine (‘SME search engine’) (126) from a user (250), a search request (214) that includes text (216) that corresponds to a particular subject matter. As mentioned above, receiving (202), a search request (214) from a user (250) may be carried out in various ways including, for example, by receiving the search request from a user through a wide area network, such as the Internet, by receiving the search request directly through user input devices, by receiving the search request as speech through microphone and converting the speech to text with a speech-to-text engine, and in other ways as will occur to readers of skill in the art.

The method of FIG. 2 also includes finding (204), in one or more information repositories (234), by the SME search engine (126) in dependence upon the text (216) of the search request (214), one or more resources (220) that includes content describing the particular subject matter. In the method of FIG. 2, finding (204), one or more resources (220) that includes content describing the particular subject matter includes determining (206) for each resource (220) a credibility rating (222). Determining (206) for each resource (220) a credibility rating (222) may be carried out in various ways including, for example, maintaining an search index of data retrieved from resources by a crawler and calculating credibility ratings for resources in the search index in dependence upon: predefined search criterion, data in the search index, and text of the search request. A search index of data retrieved from resources by a web crawler may include data of many different data types, such as, keywords in resource, number of times a keyword appears in a resource, location of keywords in a resource, markup language metatags associated with keywords in a resource, hyperlinks referencing the resource, and so on as will occur to readers of skill in the art. Predefined search criterion is a specification of various parameters used to calculate a credibility rating. Predefined search criterion used to calculate a credibility rating in accordance with embodiments of the present invention, for example, may specify particular data types of a search index, a weight or number to assign each data type in calculating the credibility rating, and so on.

Consider, for further explanation of one way to calculate a credibility rating, the following example search index, example predefined criterion, and text of a search request. In this example, the SME search engine receives a search request that includes the text, ‘chemistry.’ The example search index for the SME search engine includes a record representing a resource that is associated with the text ‘chemistry;’ a web page having a web address: www.exwebaddress.com. The search index record for www.exwebaddress.com specifies that the keyword ‘chemistry’ appears 23 times, is located once in the title of the resource as indicated by a markup language tag, and is referenced by two hyperlinks embedded in other, different web pages. The predefined criterion in this example specifies that each of these data types is used in calculating the credibility score and specifies that each is assigned a particular weight—the number of times a search term keyword appears in a resource is weighted by a factor of 1, an instance of a search term keyword in the title of a webpage is weighted by a factor of 0.7, and the number of hyperlinks referencing the resource is weighted by a factor of 2. In this example, in accordance with a search algorithm, the weighted amount of each of these numbers is added together to provide a credibility score. The credibility score of a resource therefore, in this example, may be mathematically expressed as follows:

CredibilityRating=1×n_{resource}_{_{—}}_{appearances}+0.7×nₜᵢₜₗₑ_{_{—}}_{appearances}+2×n_{hyperlink}_{_{—}}_{refs};

where, n_{resource}_{_{—}}_{appearances} is the number of appearances of a search term in a resource, nₜᵢₜₗₑ_{_{—}}_{appeareences} is the number of appearances of the search term in the resource, n_{hyperlink}_{_{—}}_{refs} is the number of hyperlinks referencing the resource. When using this predefined criterion, mathematical algorithm, and search request that includes ‘chemistry’ to calculate a credibility rating for www.exwebaddress.com, the SME search engine calculates a credibility rating of 28.4. This example credibility rating is calculated for one search term and for one resource for clarity, not limitation. Readers of skill in the art will recognize that such credibility ratings may be calculated for many resources, using multiple search terms, and that different mathematical algorithms, predefined criterion, data types, and so on may be used to make such a calculation.

The method of FIG. 2 also includes identifying (208), by the SME search engine (126), one or more potential subject matter experts (224) associated with the resources (220). Identifying (208) one or more potential subject matter experts (224) associated with the resources (220) may be carried out by finding text representing names in the resource. Such text may be found in a resource in various ways including for example through use of a database containing a plurality of names and regular expression matching. Text representing names may be in the traditional form—first name, last name—or may be an email address, a screen name for an instant messaging client, a social networking username, or any other text that may uniquely, or semi-uniquely, identify a person.

In the method of FIG. 2, identifying (208) one or more potential subject matter experts (224) associated with the resources (220) includes identifying (236) an author of a resource; identifying (238) an author cited in a bibliography of a resource; and identifying (240) a name to which a quoted portion of a resource is attributed. Identifying (236) an author of a resource may be carried out in various ways, including, for example, by finding text representing a name following the text ‘by’ or ‘author’ or the like, by retrieving the name from a markup language metatag designated for such a purpose, and in other ways as will occur to readers of skill in the art. Identifying (238) an author cited in a bibliography of a resource may be carried out in a manner similar to that of identifying (236) an author of a resource, including identifying text representing a name following the text ‘Works Cited’ or ‘Bibliography’ or the like, by retrieving names from markup language metatags designated for such a purpose, and so on as will occur to readers of skill in the art. Identifying (240) a name to which a quoted portion of a resource is attributed, may be carried out by finding text representing a name following a pair of quotation marks, by finding text representing a name in a footnote, and so on as will occur to readers of skill in the art.

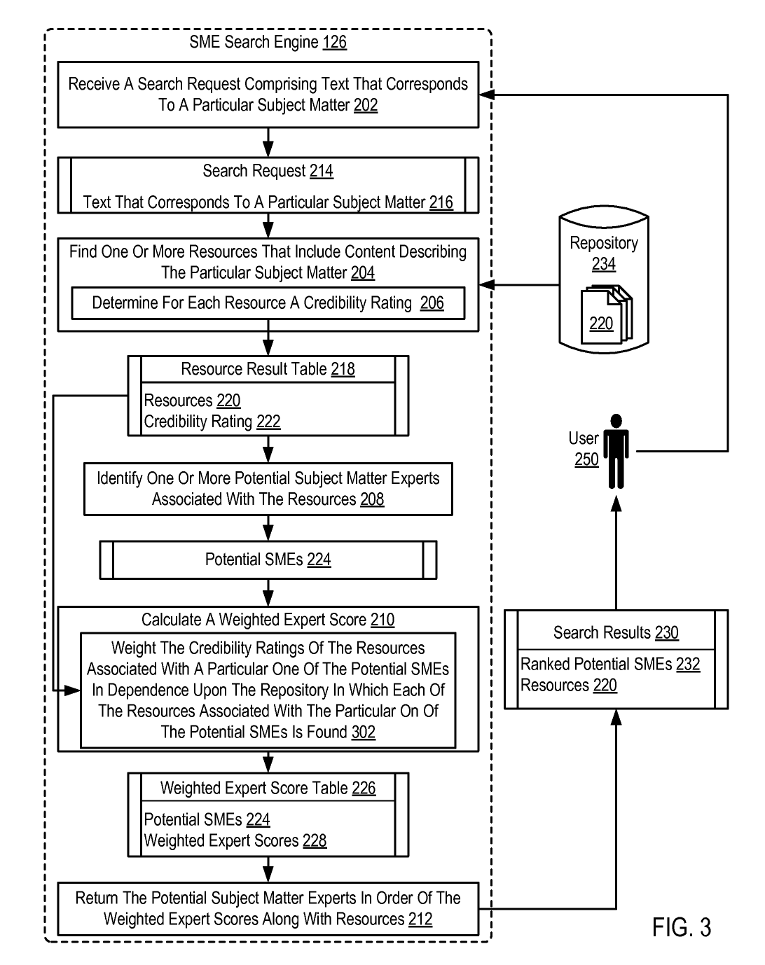

The method of FIG. 2 also includes calculating (210), for each of the potential subject matter experts (224), by the SME search engine (126), in dependence upon the credibility rating (222) of the each resource (220), a weighted expert score (228) representing an estimated level of expertise for each potential subject matter expert. The weighted expert score (228) of a potential subject matter expert may be calculated in various ways including, as one example, summing, for all resources associated with the subject matter expert, the products of the credibility ratings of each resource and number of associations between the potential subject matter expert and the resource. Such algorithm may be expressed mathematically as follows:

$$W E Score = {\sum }_{n = 1}^{∞} ( {CredibilityRatingResource}_{n} \times Associations {Resource}_{n} ) ;$$

where n is number of a resource associated with the potential subject matter expert, CredibilityRatingResourceₙ is the credibility rating of the n^{th} resource associated with the potential subject matter expert and AssociationsResourceₙ is the number of associations between the n^{th} resource and the potential subject matter expert. Consider, as an example, a potential subject matter expert that is associated three times with each of three resources, the first resource has a credibility rating of 100, the second resource has a credibility rating of 50, and the third resource has a credibility rating of 10. The weighted expert score calculated according to the above mathematical algorithm for this example potential subject matter expert is 480. Readers of skill in the art will recognize that his is only one possible mathematical algorithm among many which may be used to calculate a weighted expert score for a potential subject matter expert. Each such way of calculating a weighted expert score is well within the scope of the present invention. In fact, FIGS. 3-6 further describe various ways to calculate a weighted expert score in accordance with embodiments of the present invention.

The method of FIG. 2 also includes returning (212), to the user (250) by the SME search engine (126) as one more search results (230), the potential subject matter experts (224) in order (232) of the weighted expert scores (226) along with resources (220) associated with the potential subject matter experts (224). Returning (212) the potential subject matter experts (224) in order (232) of the weighted expert scores (226) along with resources (220) associated with the potential subject matter experts (224) may be carried out by inserting into separate records of a data structure text representing each potential subject matter expert in association with each expert's calculated weighted expert score and Uniform Resource Locators (‘URLs’) identifying resource locations of the resources associated with each potential subject matter expert; sorting the records according to the weighted expert scores; and returning the data structure to a user in the form of an email message, a text message, a webpage, return data from a java script, and so on as will occur to readers of skill in the art. Consider the following table as an example of a data structure returned to a user as a collection of search results having potential subject matter experts sorted in order of weighted expert scores.

TABLE 1
Table Of Search Results Including Potential Subject
Matter Experts Sorted By Weighted Expert Scores

| Potential Subject | Weighted | URLs of Associated |
|---|---|---|
| Matter Expert | Expert Score | Resources |
| chemguru83@freeemail.com | 95 | www.chemexample.com |
| | | www.ieee.org |
| | | www.chemistrysite.org |
| Bob Smith | 92 | www.chemnphysics.com |
| | | www.wikipedia.org/ |
| | | chemarticle |
| | | www.chemistrysite.org |
| IM:Larrymjones | 91 | www.chemicals.com |
| | | www.chemicalstore.com |

Table 1 above is an example of a data structure that includes three records, each record representing a potential subject matter expert. The records in the example table above are sorted by weighted expert score, depicted in the middle column, with higher weighted expert scores representing a greater probability that a potential subject matter expert is, in fact, an expert in a particular, searched for, subject matter. The table includes three potential subject matter experts representing in various ways: chemguru83@freeemail.com, an email address; Bob Smith, a typical first and last name; and Larrymjones and instant messaging screen name. The table also includes URLs of resources associated with each of the potential subject matter experts.

For further explanation, FIG. 3 sets forth a flow chart illustrating a further exemplary method for identifying subject matter experts according to embodiments of the present invention. The method of FIG. 3 is similar to the method of FIG. 2 in that the method of FIG. 3 is implemented by a computer and includes receiving (202) a search request (214) that includes text (216) that corresponds to a particular subject matter; finding (204) one or more resources (220) that includes content describing the particular subject matter, including determining (206) for each resource (220) a credibility rating (222); identifying (208) one or more potential subject matter experts (224) associated with the resources (220); calculating (210) a weighted expert score (228) representing an estimated level of expertise for each potential subject matter expert; and returning (212) the potential subject matter experts (224) in order (232) of the weighted expert scores (226).

The method of FIG. 3 differs from the method of FIG. 2, however, in that in the method of FIG. 3 calculating (210) a weighted expert score (228) includes weighting (302) the credibility ratings (222) of the resources associated with a particular one of the potential subject matter experts (224) in dependence upon the repository (234) in which each of the resources (220) associated with the particular one of the potential subject matter experts (224) is found. That is, in some embodiments of the present invention, the credibility rating of a resource in which a potential subject matter expert was identified, may be increased or decreased, in dependence upon the repository, or the type of repository, in which the resource is stored. The credibility rating records of a database of computer science experts may be granted more weight, for example, than the credibility rating of a web page stored on a web server or word processing document stored in a file system. The SME search engine may be configured with a table of preferred repositories, with each record of the table associating a repository with a predefined weight to be applied to the credibility rating of resources identified from the repository.

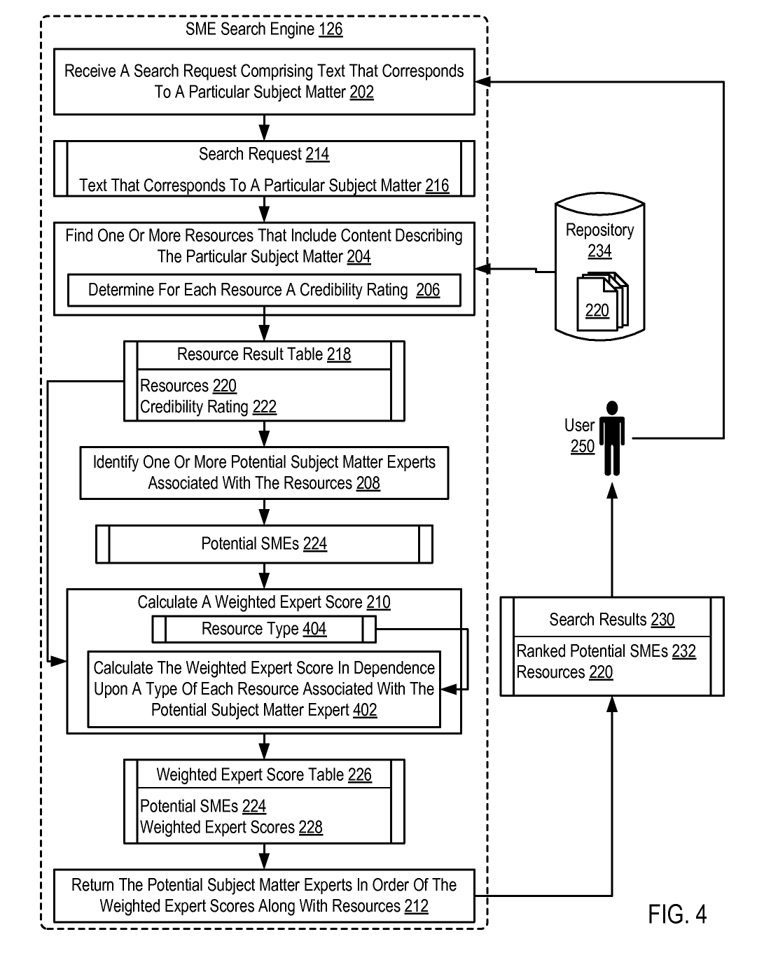

For further explanation, FIG. 4 sets forth a flow chart illustrating a further exemplary method for identifying subject matter experts according to embodiments of the present invention. The method of FIG. 4 is similar to the method of FIG. 2 in that the method of FIG. 4 is implemented by a computer and includes receiving (202) a search request (214) that includes text (216) that corresponds to a particular subject matter; finding (204) one or more resources (220) that includes content describing the particular subject matter, including determining (206) for each resource (220) a credibility rating (222); identifying (208) one or more potential subject matter experts (224) associated with the resources (220); calculating (210) a weighted expert score (228) representing an estimated level of expertise for each potential subject matter expert; and returning (212) the potential subject matter experts (224) in order (232) of the weighted expert scores (226).

The method of FIG. 4 differs from the method of FIG. 2, however, in that in the method of FIG. 4 calculating (210) a weighted expert score (228) includes calculating (402) the weighted expert score for each potential subject matter expert (224) in dependence upon a type (404) of each resource (220) associated with the potential subject matter expert (224). Examples of various types of resources include online weblogs (‘blogs’), online encyclopedia articles, journal articles, magazine articles, news articles, forums, wiki entries, and so on as will occur to readers of skill in the art. Calculating (402) the weighted expert score for each potential subject matter expert (224) in dependence upon a type (404) of each resource (220) associated with the potential subject matter expert (224) may be carried out by: identifying a type of each resource associated with a potential subject matter and weighting the credibility rating of the resource in accordance with weights specified in a preferred resource type table. A preferred resource type table may include records that associate types of resources with weights to apply to credibility ratings of resources of those types. In this example embodiment, blogs may be given less weight than news articles; wiki entries less weight than, online encyclopedia articles, and so on. That is, in this example embodiment, assuming all other things being equal, the weighted expert score of a potential subject matter expert identified from a blog will be less than a potential subject matter expert identified from a news article.

The SME search engine (126) may identify a type of each resource in various ways, including, for example, searching in the resource for keywords that identify a resource type, such as ‘magazine,’ ‘news,’ ‘blog,’ and so on. Another way in which the SME search engine (126) may identify a type of a resource is by determining the type of the resource, in dependence upon the web address of the resource, from a table of resource types in which each record associates a web address and a resource type.

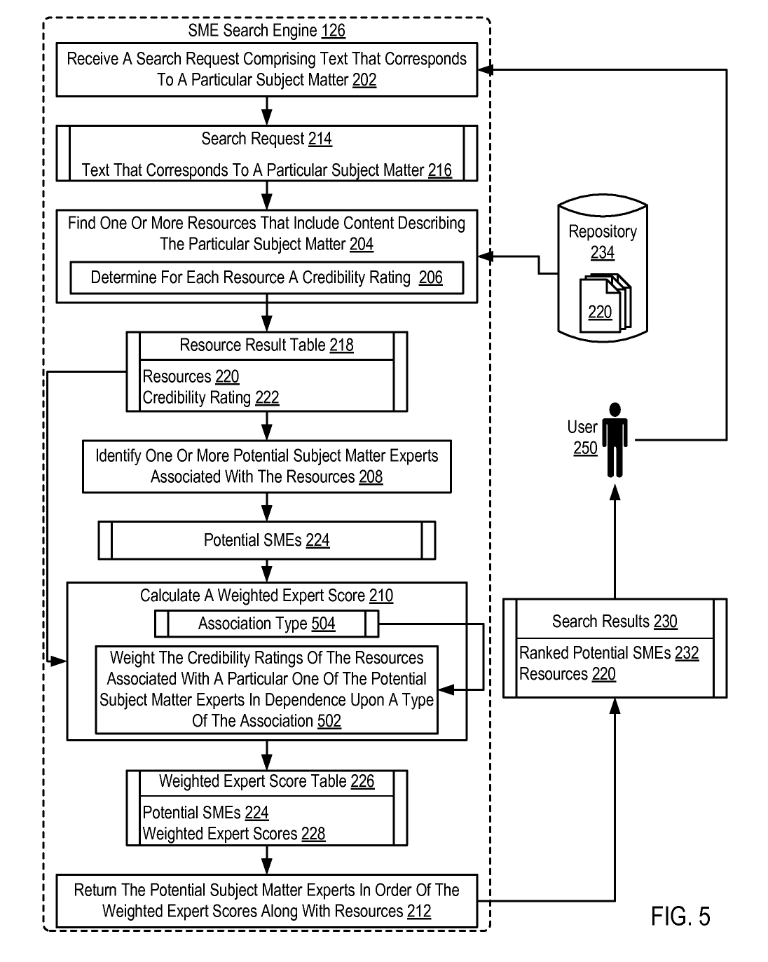

For further explanation, FIG. 5 sets forth a flow chart illustrating a further exemplary method for identifying subject matter experts according to embodiments of the present invention. The method of FIG. 5 is similar to the method of FIG. 2 in that the method of FIG. 5 is implemented by a computer and includes receiving (202) a search request (214) that includes text (216) that corresponds to a particular subject matter; finding (204) one or more resources (220) that includes content describing the particular subject matter, including determining (206) for each resource (220) a credibility rating (222); identifying (208) one or more potential subject matter experts (224) associated with the resources (220); calculating (210) a weighted expert score (228) representing an estimated level of expertise for each potential subject matter expert; and returning (212) the potential subject matter experts (224) in order (232) of the weighted expert scores (226).

The method of FIG. 5 differs from the method of FIG. 2, however, in that in the method of FIG. 5 calculating (210) a weighted expert score (228) includes weighting (502) the credibility ratings (222) of the resources (220) associated with a particular one of the potential subject matter experts (224) in dependence upon a type (504) of the association between each resource (220) and the particular one of the potential subject matter experts (224). A type of association as the term is used here describes the relationship of the identified potential subject matter expert with the resource from which the expert was identified. Examples of types of association between a potential subject matter expert and a resource include: A potential subject matter expert may be associated with a resource in the following example ways: as a name cited in a works cited portion of a resource; as a name cited in a bibliography portion of a resource; as a name quoted in a resource; as an author of a resource; as a commenter on an online forum; as a commenter on a blog, as co-author of a document, news article, magazine article; and so on as will occur to readers of skill in the art.

The SME search engine may weight (502) the credibility ratings (222) of the resources (220) in dependence upon association types (504) by: identifying the type of association between the potential subject matter expert and the resource, identifying a weight for such association type in a table of weighted association types, and weighting the credibility rating of the resource with the identified weight. Identifying the type of association may be carried out in various ways including by determining that potential subject matter expert was identified by a markup language tag indicating the potential subject matter is author, by determining that the text representing the potential subject matter expert follows text indicating a bibliography, a works cited, a co-author, and the like; by determining that potential subject matter expert that the text representing the potential subject matter expert follows exists in a field designated for a particular purpose, such as for example, a field identifying an author of a comment on a blog or wiki or a field identifying an author of blog post; or in other ways as will occur to readers of skill in the art. When the SME search engine (126) identifies the type of association the SME search engine may then determine the weight of the type by looking up the weight in a table of weighted association types. Such a table of weighted association types may include records that associate types of association between potential subject matter experts and resources and a weights for each type of association. Such a table may, for example, include records that specify a lower weight to apply to authors of resource than that to apply to a potential subject matter expert quoted in a resource.

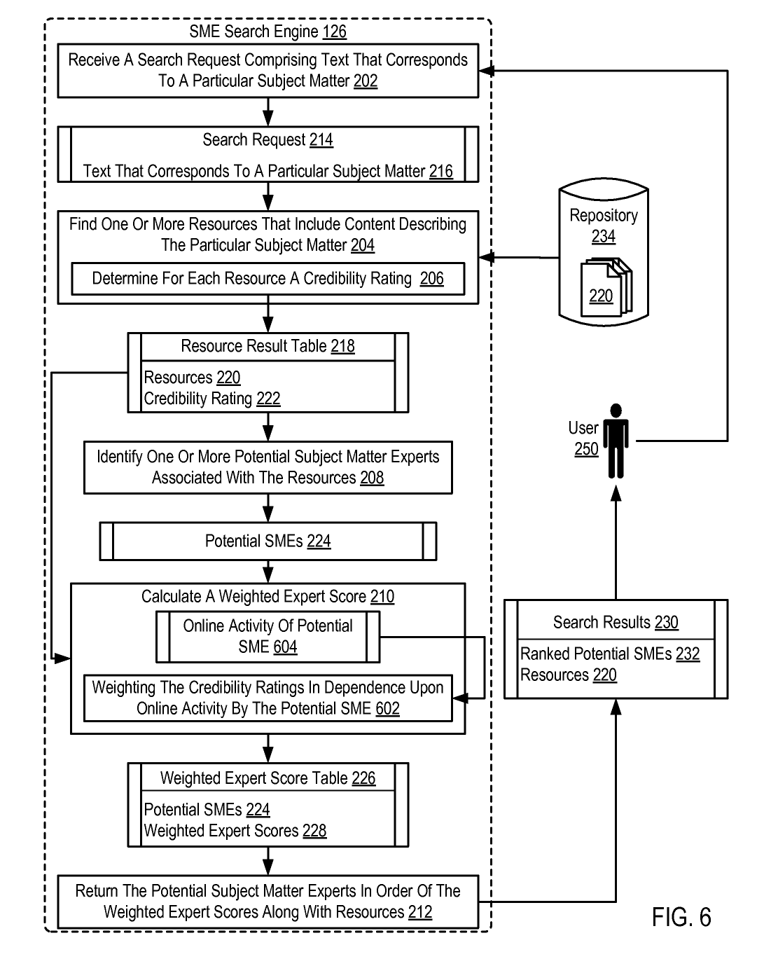

For further explanation, FIG. 6 sets forth a flow chart illustrating a further exemplary method for identifying subject matter experts according to embodiments of the present invention. The method of FIG. 6 is similar to the method of FIG. 2 in that the method of FIG. 6 is implemented by a computer and includes receiving (202) a search request (214) that includes text (216) that corresponds to a particular subject matter; finding (204) one or more resources (220) that includes content describing the particular subject matter, including determining (206) for each resource (220) a credibility rating (222); identifying (208) one or more potential subject matter experts (224) associated with the resources (220); calculating (210) a weighted expert score (228) representing an estimated level of expertise for each potential subject matter expert; and returning (212) the potential subject matter experts (224) in order (232) of the weighted expert scores (226).

The method of FIG. 6 differs from the method of FIG. 2, however, in that in the method of FIG. 6 calculating (210) a weighted expert score (228) includes weighting (602) the credibility ratings (222) of the resources (220) associated with a particular one of the potential subject matter experts (224) in dependence upon online activity (604) by the potential subject matter expert (224) corresponding to the particular subject matter in the resources (220) associated with the particular one of the potential subject matter experts (224). Online activity as the term is used in this specification refers to the quantity and frequency at which a potential subject matter expert contributes information to resources accessed via a data communications network. Examples of online activity include number and frequency of comments posted in a blog, forum, online news article, or online magazine article by a potential subject matter expert, number and frequency of blog posts authored by a potential subject matter expert, number and frequency of articles authored by the potential subject matter expert, number and frequency of web pages authored, and so on as will occur to readers of skill in the art. Weighting (602) the credibility ratings (222) of the resources (220) in dependence upon online activity (604) may be carried out by determining, for each resource in which the potential subject matter is association, the number and frequency of blog posts, authored web pages, articles, comments, and so on; and increasing or decreasing the credibility ratings of each resource accordingly. The SME search engine may be configured with predefined weights to apply for various types of online activity. Blog posts, for example, my be granted less weight than authored articles, and so on. Such predefined weights may be recorded for use by the SME search engine in a table of weighted online activity which includes records that associate types of online activities with weights. That is, when the SME search engine (126) determines and quantifies the online activity of the potential subject matter expert, the SME search engine increases or decreases that quantity in dependence upon the predefined weighting of online activity, then weights the credibility rating of the resource using the weighted quantity. Readers of skill in the art will immediately recognize that this is but one way among many possible ways to weight credibility ratings according to online activity of a potential subject matter expert, explained here for clarity only, not limitation. Other ways of weighting credibility ratings according to online activity exist and each such way is well within the scope of the present invention.

FIGS. 3-6 depict various methods of calculating (210) a weighted expert score (228) according to embodiments of the present invention. Although each such method depicted in FIGS. 3-6 is described separately for clarity of explanation, readers of skill in the art will recognize that these methods may be used in various combinations with one another. In fact, a weighted expert score may be calculated (210), according to embodiments of the present invention by using a combination of all methods depicted in FIGS. 3-6: weighting credibility ratings in dependence upon the repository; weighting credibility ratings in dependence upon resource types; weighting credibility ratings in dependence upon association types; and weighting credibility ratings in dependence upon online activity.

Exemplary embodiments of the present invention are described largely in the context of a fully functional computer system for identifying subject matter experts. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A computer-implemented method of identifying subject matter experts, a subject matter expert comprising a person adept in a particular subject matter, the method comprising:
receiving, by a subject matter expert search engine (‘SME search engine’) from a user, a search request comprising text that corresponds to a particular subject matter;
finding, in one or more information repositories, by the SME search engine in dependence upon the text of the search request, one or more resources comprising content describing the particular subject matter, including determining for each resource a credibility rating;
identifying, by the SME search engine, one or more potential subject matter experts associated with the resources;
calculating, for each of the potential subject matter experts, by the SME search engine, in dependence upon the credibility rating of the each resource, a weighted expert score representing an estimated level of expertise for each potential subject matter expert; and
returning, to the user by the SME search engine as one more search results, the potential subject matter experts in order of the weighted expert scores along with resources associated with the potential subject matter experts.

2. The method of claim 1 wherein calculating a weighted expert score representing an estimated level of expertise for each potential subject matter expert further comprises:
weighting the credibility ratings of the resources associated with a particular one of the potential subject matter experts in dependence upon the repository in which each of the resources associated with the particular one of the potential subject matter experts is found.

3. The method of claim 1 wherein calculating a weighted expert score representing an estimated level of expertise for each potential subject matter expert further comprises:
calculating the weighted expert score for each potential subject matter expert in dependence upon a type of each resource associated with the potential subject matter expert.

4. The method of claim 1 wherein calculating a weighted expert score representing an estimated level of expertise for each potential subject matter expert further comprises:
weighting the credibility ratings of the resources associated with a particular one of the potential subject matter experts in dependence upon a type of the association between each resource and the particular one of the potential subject matter experts.

5. The method of claim 1 wherein calculating a weighted expert score representing an estimated level of expertise for each potential subject matter expert further comprises:
weighting the credibility ratings of the resources associated with a particular one of the potential subject matter experts in dependence upon online activity by the potential subject matter expert corresponding to the particular subject matter in the resources associated with the particular one of the potential subject matter experts.

6. The method of claim 1 wherein identifying potential subject matter experts associated with the resources further comprises:
identifying an author of a resource;
identifying an author cited in a bibliography of a resource; and
identifying a name to which a quoted portion of a resource is attributed.

7. Apparatus for identifying subject matter experts, a subject matter expert comprising a person adept in a particular subject matter, the apparatus comprising a computer processor, a computer memory operatively coupled to the computer processor, the computer memory having disposed within it computer program instructions capable of:
receiving, by a subject matter expert search engine (‘SME search engine’) from a user, a search request comprising text that corresponds to a particular subject matter;
finding, in one or more information repositories, by the SME search engine in dependence upon the text of the search request, one or more resources comprising content describing the particular subject matter, including determining for each resource a credibility rating;
identifying, by the SME search engine, one or more potential subject matter experts associated with the resources;
calculating, for each of the potential subject matter experts, by the SME search engine, in dependence upon the credibility rating of the each resource, a weighted expert score representing an estimated level of expertise for each potential subject matter expert; and
returning, to the user by the SME search engine as one more search results, the potential subject matter experts in order of the weighted expert scores along with resources associated with the potential subject matter experts.

8. The apparatus of claim 7 wherein calculating a weighted expert score representing an estimated level of expertise for each potential subject matter expert further comprises:
weighting the credibility ratings of the resources associated with a particular one of the potential subject matter experts in dependence upon the repository in which each of the resources associated with the particular one of the potential subject matter experts is found.

9. The apparatus of claim 7 wherein calculating a weighted expert score representing an estimated level of expertise for each potential subject matter expert further comprises:
calculating the weighted expert score for each potential subject matter expert in dependence upon a type of each resource associated with the potential subject matter expert.

10. The apparatus of claim 7 wherein calculating a weighted expert score representing an estimated level of expertise for each potential subject matter expert further comprises:
weighting the credibility ratings of the resources associated with a particular one of the potential subject matter experts in dependence upon a type of the association between each resource and the particular one of the potential subject matter experts.

11. The apparatus of claim 7 wherein calculating a weighted expert score representing an estimated level of expertise for each potential subject matter expert further comprises:
weighting the credibility ratings of the resources associated with a particular one of the potential subject matter experts in dependence upon online activity by the potential subject matter expert corresponding to the particular subject matter in the resources associated with the particular one of the potential subject matter experts.

12. The apparatus of claim 7 wherein identifying potential subject matter experts associated with the resources further comprises:
identifying an author of a resource;
identifying an author cited in a bibliography of a resource; and
identifying a name to which a quoted portion of a resource is attributed.

13. A computer program product for identifying subject matter experts, a subject matter expert comprising a person adept in a particular subject matter, the computer program product disposed in a computer readable recording medium, the computer program product comprising computer program instructions capable of:
receiving, by a subject matter expert search engine (‘SME search engine’) from a user, a search request comprising text that corresponds to a particular subject matter;
finding, in one or more information repositories, by the SME search engine in dependence upon the text of the search request, one or more resources comprising content describing the particular subject matter, including determining for each resource a credibility rating;
identifying, by the SME search engine, one or more potential subject matter experts associated with the resources;
calculating, for each of the potential subject matter experts, by the SME search engine, in dependence upon the credibility rating of the each resource, a weighted expert score representing an estimated level of expertise for each potential subject matter expert; and
returning, to the user by the SME search engine as one more search results, the potential subject matter experts in order of the weighted expert scores along with resources associated with the potential subject matter experts.

14. The computer program product of claim 13 wherein calculating a weighted expert score representing an estimated level of expertise for each potential subject matter expert further comprises:
weighting the credibility ratings of the resources associated with a particular one of the potential subject matter experts in dependence upon the repository in which each of the resources associated with the particular one of the potential subject matter experts is found.

15. The computer program product of claim 13 wherein calculating a weighted expert score representing an estimated level of expertise for each potential subject matter expert further comprises:
calculating the weighted expert score for each potential subject matter expert in dependence upon a type of each resource associated with the potential subject matter expert.

16. The computer program product of claim 13 wherein calculating a weighted expert score representing an estimated level of expertise for each potential subject matter expert further comprises:
weighting the credibility ratings of the resources associated with a particular one of the potential subject matter experts in dependence upon a type of the association between each resource and the particular one of the potential subject matter experts.

17. The computer program product of claim 13 wherein calculating a weighted expert score representing an estimated level of expertise for each potential subject matter expert further comprises:
weighting the credibility ratings of the resources associated with a particular one of the potential subject matter experts in dependence upon online activity by the potential subject matter expert corresponding to the particular subject matter in the resources associated with the particular one of the potential subject matter experts.

18. The computer program product of claim 13 wherein identifying potential subject matter experts associated with the resources further comprises:
identifying an author of a resource;
identifying an author cited in a bibliography of a resource; and
identifying a name to which a quoted portion of a resource is attributed.
